(19) United States
(12) Patent Application Publication
(10) Pub. No.: US 2013/0123530 A1
(43) Pub. Date: May 16, 2013

(54) Hydrophilic Polyorganosiloxanes

(71) Applicants: Paul Boehm, Mainz (DE); Holger Frey, Emmendingen (DE); Tammo J. Menke, Koln (DE)

(72) Inventors: Paul Boehm, Mainz (DE); Holger Frey, Emmendingen (DE); Tammo J. Menke, Koln (DE)

(73) Assignee: MOMENTIVE PERFORMANCE MATERIALS GMBH, Leverkusen (DE)

(21) Appl. No.: 13/643,568

(22) PCT Filed: Apr. 20, 2011
(86) PCT No.: PCT/EP2011/056345

§ 371 Date: Jan. 23, 2013

(30) Foreign Application Priority Data
Apr. 26, 2010 (DE) 102010028182.4

(51) Int. Cl. C07F 7/08

(52) U.S. Cl. CPC C07F 7/0854; C07F 7/0852
USPC 556/423; 556/446

(57) ABSTRACT

The invention relates to glycerol-modified polyorganosiloxane compounds with high hydrophilicity and their use.

The invention relates to hydrophilic polyorganosiloxane compounds prepared by reacting functionalized polyorganosiloxane compounds with glycidol. The hydrophilic polyorganosiloxane compounds have special properties which render them suitable, in particular, as additives for surface treatment, modifiers and raw materials for elastomers or foams, emulsifiers, wetting agents, lubricant applications as well as foam stabilizers, defoaming agents or the like.

### PRIOR ART

Hydrophilic polyorganosiloxane compounds are used, for instance, for hydrophilization of surfaces such as those of silicone elastomers, as reactive component in foams, as defoaming agents in hydrocarbons or as foam stabilizers in the preparation of rigid or flexible polyurethane foams. In the past, polar groups, such as polyether groups or ionic groups were, for example, introduced into polyorganosiloxane compounds in order to hydrophilize polyorganosiloxane compounds (e.g. DE 19748606 A1, EP 881249 A1). In some applications, however, these polyorganosiloxane compounds known from the prior art have too low a level of hydrophilicity, which is expressed by too large a contact angle at the interface to water or a limited solubility in polar solvents, such as alcohols.

Biomedical molded bodies based on cross-linkable polyorganosiloxanes are known from EP 035080, which comprise, for instance, silicon-bonded propoxypropane-1,2-diol residues that are obtained by a hydrosilylation reaction with protected 3-allyloxy-propane-1,2-diol and subsequent separation of the protective group. Similar compounds are described in EP-A-0266895 and U.S. Pat. No. 6,255,429 B1.

Glycidol-functionalized polyorganosiloxanes with more than one gylcidol unit per siloxane unit are not described.

The present invention was based on the object of providing novel hydrophilic polyorganosiloxane compounds with an increased hydrophilicity or increased solubility in polar media, which, among other things, serve as emulsifiers. Moreover, the present invention was based on the object of providing novel hydrophilic polyorganosiloxane compounds with an increased durability on hydrophobic surfaces, particularly on polyorganosiloxanes.

By grafting functionalized polyorganosiloxane parent compounds with glycidol, the inventors of the present patent application were able to provide novel polyorganosiloxane compounds with an increased hydrophilicity or increased solubility in polar media.

Therefore, polyorganosiloxane compounds, which can be obtained by reacting polyorganosiloxane compounds of the formula (I), are the subject matter of the invention:

[MₐD_{b}T_{c}Q_{d}]ₑ (I)

wherein

M=R₃SiO_{1/2},

D=R₂ SiO_{2/2},

T=RSiO_{3/2},

Q=SiO_{4/2},

with

a=1-10

b=0-1000

c=0-1

d=0-1

e=1-10

wherein

R=is an organic group,

provided that R comprises at least one group R¹,

wherein R¹ is a monovalent, straight-chained, cyclic or branched, saturated or unsaturated C₁ to C₂₀ hydrocarbon residue, which can contain one or more groups selected from —O— and

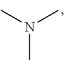

and which comprises at least one group selected from —OH, —SH, —NH— and —NH₂,

with a glycidol compound of the formula (II),

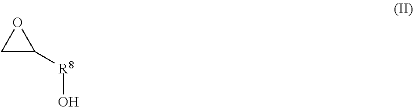

wherein R⁸ is selected from divalent C_{1 to} C₈ hydrocarbon residues, such as, in particular, methylene (—CH₂—),

provided that the obtained polyorganosiloxane compounds comprise at least one residue R¹ which comprises polyglycidol residues of the formula

-(glycidol)ₓ

wherein x>1, wherein the polyglycidol residue is formed by ring-opening polymerization of the epoxy groups of the gycidol molecules of the formula (II).

Preferably, R⁸ is methylene, so that the preferred glycidol compound of the formula (II) is glycidol of the formula:

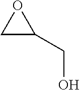

Further glycidol compounds include, for example,

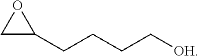

A significant increase of hydrophilicity due to the formation of hydoxyl groups and ether groups is achieved by introducing several glycidol groups into the side chains of the polyorganosiloxanes. In particular, the polyglycidol side chains comprise at least three hydroxy groups and at least two ether groups (—O—), as can be seen, for example, in the following formula:

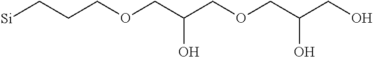

The parent compounds of the formula (I) are generally prepared by hydrosilylation of SiH-functional polyorganosiloxane compounds with unsaturated, functionalized compounds comprising at least one group selected from —OH, —SH, —NH— and —NH₂ or protected derivatives thereof, in which hydrogen in said groups was replaced by protective groups, which in an additional step can be reconverted into —OH, —SH, —NH— or —NH₂ groups.

SiH-functional polyorganosiloxane compounds include, for example:

Linear, cyclic or branched polyorganosiloxanes, whose siloxy units are expediently selected from M=R₃SiO_{1/2}, M^{H}=R₂HSiO_{1/2}, D=R₂SiO_{2/2}, D^{H}=RHSiO_{2/2}, T=RSiO_{3/2}, T^{H}=HSiO_{3/2}, Q=SiO_{4/2}, in which these units are preferably selected from MeHSiO or Me₂HSiO_{0.5} units and optionally other organosiloxy units, preferably dimethylsiloxy units. The polyorganohydrogensiloxanes can be described, for example, by the general formula (I-H), wherein, for the purpose of abbreviation, the symbol M* represents M and M^{H}, D* represents D and D^{H}, and T* represents T and T^{H}:

[M*ₐD*_{b}T*_{c}Q_{d}]ₑ (I-H)

wherein the indices a-e are defined as above.

The siloxy units can be present in a blockwise or statistically linked form in the polymer chain. Each siloxane unit of the polyorganosiloxane chain can carry identical or different residues.

The indices of the formula (I-H) describe the mean degree of polymerization Pₙ measured as number-average Mₙ per GPC, in relation to polyhydrogenmethylsiloxanes. Thus, other siloxy groups result in other molecular weights within the predetermined viscosity limits. The preferred polyorganohydrogensiloxanes are structures selected from the group that can be described by the formulae (I-Ha-I-Hf)

HR₂SiO(R₂SiO)_{z}(RHSiO)ₚSiR₂H (I-Ha)

HMe₂SiO(Me₂SiO)_{z}(MeHSiO)ₚSiMe₂H (I-Hb)

Me₃SiO(Me₂SiO)_{z}(MeHSiO)ₚSiMe₃ (I-Hc)

Me₃SiO(MeHSiO)ₚSiMe₃ (I-Hd)

{[R₂R⁶SiO_{1/2}]₀₋₃[R⁶SiO_{3/2}][R⁵O]₀₋₁}₁₋₂₀₀ (I-He)

{[SiO_{4/2}}][R⁵O_{1/2}]₀₋₁[R₂R⁶SiO_{1/2}]_{0.01-10}[R⁶SiO_{3/2}]₀₋₅₀[RR⁶SiO_{2/2}]}₁₋₁₀₀₀ (I-Hf)
z=0 to 1000,
p=0 to 100,
z+p=0 to 1000,
wherein R⁵O_{1/2} is a C₁ to C₆ alkoxy residue on the silicon,
R⁶=is hydrogen (H) or R, wherein at least one residue R⁶ must be hydrogen. R is defined above; preferably R=methyl.

Particularly preferably,

HMe₂SiO(Me₂SiO)_{z}(MeHSiO)ₚSiMe₂H (I-Hb)
wherein p=0, i.e. α,ω-dimethylhydrogen-terminated polydimethylsiloxanes.

The polyorganohydrogensiloxanes are preferably liquid at room temperature, i.e. they preferably have fewer than 1000 siloxy units, i.e. they preferably have viscosities below 40 Pa·s at 25° C. and D=1 s⁻¹.

The unsaturated compounds which are reacted by means of hydrosilylation reaction with the polyorganohydrogensiloxanes, and which serve for introducing the functional groups selected from —OH, —SH, —NH— and —NH₂, are selected, for example, from:

Unsaturated, straight-chained, cyclic or branched compounds with 2 to 20 carbon atoms which may contain one or more groups selected from —O— and

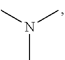

and which comprise at least one group selected from —OH, —SH, —NH— and —NH₂ or correspondingly protected residues of these groups.

The unsaturated group is preferably a CH₂═CH or HC≡C group.

Preferred such compounds are, for example:

Allyl alcohol, allylamine,

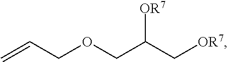

wherein R⁷ is a hydroxy protective group, such as trimethylsilyl, or two groups R⁷ represent an alkandiyl residue, forming a cyclic dioxolane compound, such as 4-allyloxymethyl-2,2-dimethyl-[1,3]dioxolane:

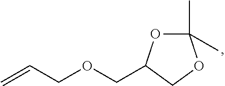

the de-protected derivative (without protective group) thereof:

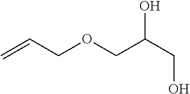

propargyl alcohol, butinol, cyclohexinol, and OH-protected derivatives thereof.

Customary hydrosilylation catalysts include, for example:

Transition metals, selected from the group consisting of platinum, rhodium, ruthenium, palladium, nickel, iridium and their compounds. Platinum or platinum compounds are preferably used as hydrosilylation catalyst. Vinylpolysiloxane-Pt(0) complex compounds, alkenylpolysiloxane-Pt(0) complex compounds, cyclohexene-Pt(0) complex compounds, or the like, such as described in B. Marciniec: Comprehensive Handbook on Hydrosilylation Pergamon Press Ltd., are preferred.

The quantity of the hydrosilylation catalyst, in particular of the platinum catalyst, is 0.1-1000 ppm, computed as metal, based on the weight of the hydrogensiloxane compound and the unsaturated, functionalized compound.

1-50 ppm metal or metal compounds, in particular platinum or platinum compounds, are more preferred, the indication of quantity relating to the metal (in particular platinum), still more preferably 2-24 ppm, even more preferably 3 to 15, most preferably 4 to 9.5 ppm.

In the group of the Pt, Rh, Ir, Pd, Ni and Ru compounds, i.e. the salts, complexes or metals thereof, the hydrosilylation catalyst is selected, for example, from the Pt catalysts, in particular Pt⁰ complex compounds with olefins, particularly preferably with vinyl siloxanes, such as, for example 1:1 complexes with 1,3-divinyltetramethyldisiloxane and/or tetravinyltetramethyltetracyclosiloxane, amine, azo or phosphite complex compounds.

These Pt catalysts are mentioned by way of example in U.S. Pat. No. 3,715,334 or U.S. Pat. No. 3,419,593. The preferably used Pt⁰ olefin complexes are prepared in the presence of 1,3-di-vinyltetra-methyldisiloxane (M^{Vi}₂)by reduction of hexachloroplatinic acid or of other platinum chlorides.

Of course, other platinum compounds, provided they permit rapid cross-linking, can be used, such as the photoactivatable Pt catalysts of EP 122008, EP 146307 or U.S. 2003-0199603.

For economic reasons, quantities between 10 to 300 ppm metal are preferred, quantities below 10 ppm ensure an only low reaction rate or can be inhibited by contaminations. All solid substances can be selected as carriers for the catalysts provided they do not inhibit the hydrosilylation in an undesired manner. The carriers can be selected from the group of powdery silicic acids or gels or organic resins or polymers. Expediently, they are selected so that a good separation of the solid can take place after hydrosilylation.

The polyorganosiloxane compounds of the formula (I) obtained from the reaction of the polyorganohydrogensiloxane compounds with unsaturated functionalized compounds preferably comprise siloxy units selected from the following formulae:

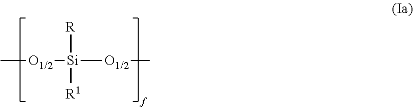

wherein

R, if several of the aforementioned siloxy units are present, can be the same or different and is selected from C₁ to C₂₂ alkyl, which can optionally be substituted by one or more fluorine atoms, C₂ to C₂₂ alkenyl, and C₆-C₁₀ aryl,

R¹ is defined as above, and

f is 0-600.

The C₁ to C₂₂ alkenyl groups are expediently inserted therein after the hydrosilylation, but prior to reacting with glycidol, by means of an equilibration or condensation reaction.

The D units furthermore comprise siloxy groups of the following formula,

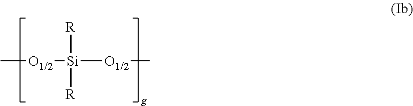

wherein R can be the same or different in a single siloxy unit or, if several siloxy units are present, can be the same or different in different ones of the siloxy units and is selected from C₁ to C₂₂ alkyl, which can optionally be substituted by one or more fluorine atoms, C₂ to C₂₂ alkenyl, and C₆-C₁₀ aryl, and

g is from 0-700,

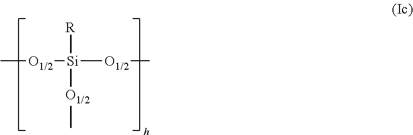

wherein R, if several of the aforementioned siloxy units are present, can be the same or different and is selected from C₁ to C₂₂ alkyl, which can optionally be substituted by one or more fluorine atoms, C₂ to C₂₂ alkenyl, and C₆-C₁₀ aryl, and

h is from 0-10,

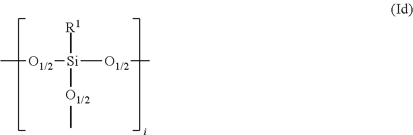

wherein R¹, is defined as above, and

i is from 0-10,

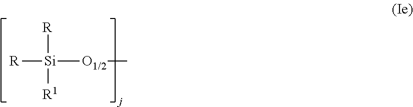

wherein R, if several of the aforementioned siloxy units are present, can be the same or different and is selected from C₁ to C₂₂ alkyl, which can optionally be substituted by one or more fluorine atoms, C₂ to C₂₂ alkenyl, and C₆-C₁₀ aryl,

R¹ is defined as above, and

j=0-30,

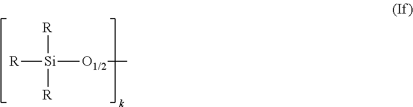

wherein R, if several of the aforementioned siloxy units are present, can be the same or different and is selected from C₁ to C₂₂ alkyl, which can optionally be substituted by one or more fluorine atoms, C₂ to C₂₂ alkenyl, and C₆-C₁₀ aryl, and

k is from 0-30,

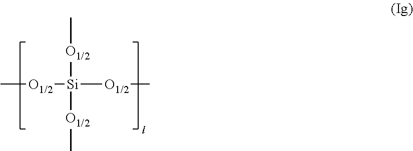

wherein 1=0=10,

f+g+h+i+j+k+l=12 to 1000.

In the siloxy units with the indices f to 1, the C₂ to C₂₂ alkenyl groups are expediently inserted after the hydrosilylation, but prior to reacting with glycidol, by means of an equilibration or condensation reaction, because they are not supposed to participate in this hydrosilylation reaction.

In a preferred embodiment of the present invention, the polyorganosiloxane compounds comprise two or more, preferably from 2 to 1000, residues R¹.

In a further preferred embodiment of the present invention the parent compounds of the formula (I) satisfy one or more of the following features:

R is selected from: C₁ to C₁₀ alkyl, which can optionally be substituted with 1 to 13 fluorine atoms, preferably methyl, C₂ to C₈ alkenyl, and phenyl,

R¹ is selected from: monovalent, straight-chained, cyclic or branched, saturated or unsaturated C₁ to C₁₀ hydrocarbon residues, which may contain one or more groups selected from —O— and

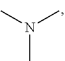

and which comprise at least one group selected from —OH, —NH— and —NH₂,

f=1 to 200, preferably 1 to 100, preferably 1 to 50, preferably 1 to 30, preferably 3 to 30, preferably 5 to 30,

g=10 to 700, preferably 10 to 200, preferably 10 to 150, preferably 20 to 150, preferably 30 to 150, preferably 30 to 100,

h=0 to 5 and preferably 0,

i=0 to 5 and preferably 0,

l=0 to 5 and preferably 0,

f+g+h+i+j+k+l=10 to 500, preferably 10 to 200, preferably 10 to 150, preferably 20 to 150, preferably 30 to 150, preferably 30 to 100.

In a further preferred embodiment of the present invention the compounds of the formula (I) satisfy one or more of the following features:

R is selected from: C₁ to C₆ alkyl, which can optionally be substituted with 1 to 13 fluorine atoms, with methyl, C₂ to C₈ alkenyl, preferably vinyl, and phenyl being preferred,

R¹ is selected from: monovalent, straight-chained, cyclic or branched, saturated or unsaturated C₂ to C₁₀ hydrocarbon residues, which may contain one or more groups selected from —O— and

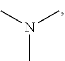

and which comprise at least one group —NH₂.

In a further preferred embodiment of the present invention, the polyorganosiloxane compounds according to the invention comprise residues R², which arose from the reaction of residues R¹ with several glycidol molecules by ring-opening of the epoxide, as shown by way of example below:

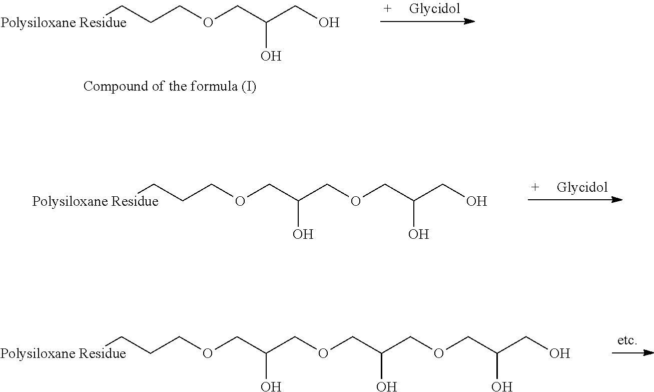

In this case, the reaction scheme is to be understood to be schematic. The addition of the gycidol molecules can also take place on other hydroxy groups, for example while forming dendritical dendrimer hydrophilic side chains, such as, for example:

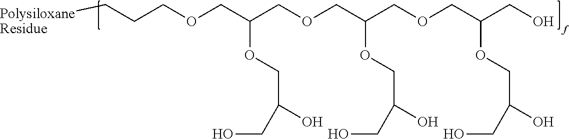

or, particularly if α,ω-funktional polysiloxane compounds are used, difunctional polysiloxane compounds of the form:

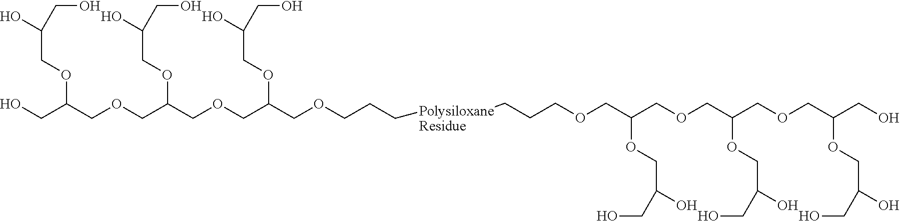

wherein, in the present case, five gycidol molecules per side chain R¹ have added, in each case to the parent compound of the formula (I), and wherein f represents the index of a corresponding D unit

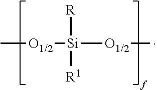

The reaction of the parent compounds of the formula (I) with glycidol preferably takes place in polar organic solvents, such as tetrahydrofuran, dioxane, DMF etc., at temperatures of 20 to 100° C. and subsequent removal of excess glycidol and solvents. In this case, glycidol is naturally used in molar excess in relation to the molar quantity of the residues R¹, so that on average at least about two, preferably at least three, more preferably at least four gycidol molecules have added to an NHR, NH₂, SH or OH modified siloxy unit (-(Gly)_{>2}). The reaction preferably takes place in the presence of alkaline catalysts that do not enter into a reaction with glycidol, and which do not depolymerize the polysiloxane chain, such as, for example alkali alcoholates, such as tert.-butyl potassium. In case amino-functional starting compounds of the formula (I) are used, the presence of an alkaline catalyst, surprisingly, is not necessary in many cases.

In this way, highly hydroxy-containing polydiorganosiloxanes with a totally new property profile, among other things, with the highest hydrophilicity, can be prepared, which makes new applications accessible.

The polyorganosiloxane compounds according to the invention therefore expediently comprise polyglycidol residues of the formula

(glycidol)ₓ

wherein x is from 2 to 20, preferably 4 to 18, and the polyglydol residue is formed by ring-opening polymerization of the epoxy groups of the glycidol, as as explained above.

The residues R¹ in the compounds of the formula (I) are expediently selected from the residues of the formula:

—R³—Y,

wherein R³ is selected from monovalent, straight-chained, branched or cyclic alkyl residues with up to 20 carbon atoms, which may optionally comprise one or more ether groups —O— and which may optionally be substituted with one or more hydoxyl groups, and wherein Y is at least one group selected from —OH, —SH, —NH₂ or —NHR⁴, wherein R⁴ is selected from straight-chained, branched or cyclic alkyl residues with up to 10 carbon atoms. To these compounds, the glycidol compounds of the formula (H) add:

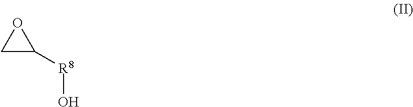

wherein R⁸ is defined as above,

in particular glycidol:

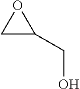

to the residues Y while opening the ring of the epoxide ring and continuing the oligomerization or polymerization of further gycidol molecules to the continuously arising free hydroxy groups.

In a particularly preferred embodiment, the polyorganosiloxane compounds are prepared from compounds of the formula (I), wherein R¹ is selected from residues of the formula:

—(CH₂)₃—O—X—Y

wherein X is selected from the group consisting of:

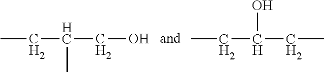

and Y is as defined above, preferably hydroxy or amino,

—(CH₂)ₙ—Y

wherein n is 1 to 8 and Y is as defined above, preferably hydroxy or amino, and

—R³—Y, wherein R³ is an alkyl group with 8 to 20 carbon atoms, which comprises a cycloalkyl group, and Y is as defined above, preferably hydroxy or amino.

In another preferred embodiment, the parent compounds of the formula (I), in relation to the total amount of the siloxy units, comprise at least 25 mol-% siloxy units, which comprise residues R¹, which comprise functional groups that are capable of reacting with glycidol compounds of the formula (II).

In another preferred embodiment of the polyorganosiloxane compounds according to the invention, the molar ratio of the residues R¹ to the glycidol connecting units, in relation to the glycidol compounds of the formula (II) in the polyorganosiloxane compounds obtained is at least 1:4, preferably at least 1:5.

In another preferred embodiment of the polyorganosiloxane compounds according to the invention, they comprise at least 8 mmol hydoxyl groups per gram of the polysiloxane compound according to the invention.

In particular, the polyglycidol side chains comprise at least three (3), preferably at least 4, still more preferably at least 5 hydroxy groups per side chain R¹, as can be seen, for example, in the following formula:

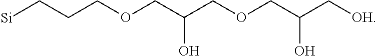

A particularly preferred embodiment of the polyorganosiloxane compounds according to the invention is shown in the following general formula:

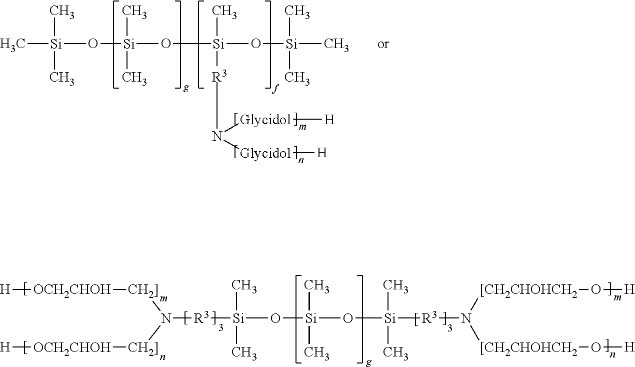

wherein

f=1 to 200, preferably 1 to 100, preferably 1 to 50, preferably 1 to 30, preferably 3 to 30, preferably 5 to 30,

g=10 to 700, preferably 10 to 200, preferably 10 to 150, preferably 20 to 150, preferably 30 to 150, preferably 30 to 100,

R³ is defined as above,

m=0 to 20,

n=0 to 20, and

m and/or n≧2, and

glycidol means a glycidol unit arising from the epoxide ring-opening reaction of glydol compounds of the formula (II).

The present invention further relates to a method for preparing the polyorganosiloxane compounds according to the invention, characterized in that compounds of the formula (I) are reacted with glycidol compounds of the formula (II), preferably with glycidol itself. With respect to the reaction conditions, reference can be made to the above descriptions as well as to the examples.

Preferably, in the method according to the invention for the preparation of the polyorganosiloxane compounds, parent compounds of the formula (I) are reacted with more than 1 mol, preferably more than 2 mol, more preferably more than 3 mol, still more preferably more than 4 mol of the glycidol compounds of the formula (II) per residue R¹. The higher the excess of glycidol compounds used, the higher the number of the gylcidol units in the residues R², and the higher the hydrophilicity of the polysiloxane compounds obtained.

The present invention further relates to the use of the polyorganosiloxane compounds according to the invention as
emulsifier,
defoaming agent,
coagulant (coagulating agent) for rubber latices
phase separating agent in crude oil extraction
hydrophilization additive,
wetting agent and adjuvant in plant protection emulsions
anti-static agent,
anti-fogging coating
hydrogen-forming additive in Si—H group-containing compositions,
fiber treatment agent,
foam stabilizer, in particular for rigid and flexible polyurethane foams,
cross-linking component in the production of elastomers or elastomeric foams.

The present invention further relates to the use of the polyorganosiloxane compounds according to the invention for the preparation of cosmetic formulations.

Preferably, the polyorganosiloxane compounds according to the invention are used as emulsifiers, in dishwasher compositions, detergent compositions, hydrophilization additive, wetting agent or adjuvant for the effective application of plant protection agents, as additives for the oil-water phase separation in crude oil extraction, as softeners for natural and synthetic fibers and pulps including paper, as a defoaming agent for diesel fuel, as an anti-static agent, as hydrogen-forming additive in Si—H group-containing compositions, and/or as a foam stabilizer, in particular in the production of poylurethane foams.

In the field of cosmetics, there is a demand for the replacement of polyethylene oxide-based W/O or O/W emulsifiers by emulsifiers that have as small an allergenic action as possible. The assignment of the group of the W/O or O/W emulsifiers can be made by referring to the so-called HLB values (hydrophilic-lipohilic balance). Preferably, W/O emulsifiers typically have a value of <8.

The hydrophilicity of the polyorganosiloxane compounds according to the invention can be controlled by means of two parameters, in particular:
the molar quantity of the glycidol units per residue R², and
the molar ratio of the hydrophilized siloxy units with R² arising from R¹.

Preferably, the molar ratio in the polysiloxane compounds according to the invention of the hydrophilic siloxy residues with the indices f, i and/or j to the lipophilic, i.e. “non-modified” siloxy units containing only R with the indices g, h and/or k is from 5:1 to 1 : 10, more preferably from 2:1 to 1:7, still more preferably from 1:1 to 1:5.

The polysiloxane compounds in which the ratio of the hydrophilic groups with the indices (f+i+j) to the hydrophobic groups (g+h+k)<1 (i.e. fewer hydrophilic compounds), are preferably used for their use as W/O emulsifiers, as foam stabilizer for rigid and flexible polyurethane foams, particularly rigid foams, or also as a defoaming agent, such as in defoaming formulations in hydrocarbons, such as, for example, for diesel fuel or as a defoaming agent. Preferably, this group has an HLB value of <8.

Another preferred embodiment of the invention is the use of the polyorganosiloxanes that are hydrophilically modified to a lesser extent as an emulsifier or adjuvant in compositions for forestry and agriculture and gardening.

The polysiloxane compounds preferred here, in which the ratio (f+i+j) to (g+h+k)<1 (fewer hydrophilic compounds), for this use preferably consist of linear polyorganosiloxanes with a mean chain length of 1-100 D units corresponding to the indices g+f. These compounds improve the dispersability of the active materials and stabilize the emulsions if they are diluted with additional water.

Many pesticides require, for application on a plant, a form of administration with an additional adjuvant in order to be able to spray the plant protection composition, to wet the leaf and to disperse and retain the active substances on the leaf Frequently, the adjuvant is a wetting agent that takes on a variety of other functions. Among other things, it may also aid in transporting the bioactive active substances through the cell wall. The adjuvants can be admixed both directly to the plant protection compositions as well as as an additional component from a separate auxiliary tank.

Typical composition are mentioned, for example, in WO 2008/116863, pages 16-18, which are to be incorporated herein by citing them for a detailed explanation of the description:

In a typical pesticide composition, the polysiloxanes according to the invention are present in an amount of 0.005% to 2% by wt. This relates to the undiluted as well as the diluted plant protection composition.

Optionally, the plant protection compositions can contain auxiliary substances, co-surfactants, solvents, antifoam agents, deposition aids, drift retardants, fertilizers and the like.

Solvents include: solvents that are liquid at 25° C., for example water, alcohols, aromatic solvents, oils (i.e. mineral oils, vegetable oils, silicone oils, etc), C₁-C₈ alkyl esters of vegetable oils, fatty acids, glycols, such as also 2,4-trimethyl, 1,3-pentanediol, N-methyl-pyrrolidone and other solvents mentioned as reference in U.S. Pat. No. 5,674,832.

Another preferred embodiment of the invention is the use of the polyorganosiloxanes that are hydrophilically modified to a greater or lesser extent in coating compositions. Exemplary coatings compositions may include the compounds according to the invention as a wetting agent or surfactant compound for the purpose of emulsification, compatibilization of coating components, as a leveling agent, flow enhancement agent, deaerator for the reduction of surface defects. Additionally, the compounds according to the invention may cause improvements of the properties of the dried, cured paint film, such as improved abrasion resistance, anti-blocking behavior, hydrophilic or hydrophobic properties. The coating compositions may be provided both as solvent-based coatings as well as as water-based coating compositions or powder compositions.

The coatings compositions relate to architectural coatings, original equipment coatings such as automotive coatings and coil coatings, special applications such as industrial maintenance coatings and in shipbuilding and other marine coatings, i.e. in particular sea-water contact.

Typical binding agents include polyester resins, alkyd resins, epoxy resins and polyurethane resins or polymers.

In another preferred use, the polysiloxanes that are hydrophilically modified to a lesser extent, in which the indices of the siloxy units have a ratio of (f+i+j) to (g+h+k)<1, are used in defoaming diesel oils or diesel fuels, with the concentration of silicon in the diesel oil being below 5 ppm, still more preferably below 2 ppm. Another preferred use is the use of the polysiloxanes that are hydrophilically modified to a lesser extent with (f+i+j) to (g+h+k)<1 as a foam stabilizer in cold-curing or hot-curing rigid or flexible polyurethane foams, preferably in quantities of 0.5 to 5% by wt., more preferably 1 to 3% by wt. per used polyol component, with additional expanding agents whose boiling point is between—60 to 50° C., such as cyclopentane, iso-pentane and/or iso-butane. The ratio of (f+i+j) to (g+h+k) preferably is 1:1 to 15, more preferably 1:2 to 9. The sum of siloxy units (f+i+j+g+h+k) is 15 to 200, more preferably 30 to 150, measured as mean degree of polymerization Pn based on the number average Mn from a determination of molecular weight by means of gel permeation chromatography (GPC). Preferably, linear polyorganosiloxanes with the siloxy units having the indices f and g are used.

By altering the ratio of the hydrophilic indices f, h and/or j to the lipophilic indices g, i and/or k, the solubility properties can be changed significantly.

If the ratio of hydrophilic indices to the lipophilic indices is equal to or greater than 1, effects such as a reduced sliding friction, anti-static properties on hydrophobed surfaces can, in particular, be obtained. If the ratio (f+i+j) to (g+h+k) is equal to 1 or greater than 1 (more hydrophilic compounds), a use as a wetting agent, compatibilizer with regard to lipophilic phases, e.g. emulsifier in O/W emulsions. The HLB values for these more hydrophilic polysiloxanes is preferably >8.

In this case, the use as a heat-sensitizable coagulant (heat-sensitizable phase separating agent, coagulating agent) in natural rubber compositions for the manufacture of rubber articles from latices of different emulsion polymerisates, such as SBR or NBR natural rubber latex, is preferred. The latices serve for manufacturing rubber gloves, condoms or other balloons. The use of the hydrophilic polysiloxanes according to the invention prevents the premature heat-activated coagulation of the latices at room temperature. The point of coagulation is displaced to >35° C. The polyorganosiloxanes of this group can also be used as phase separating agents for cracking emulsions in the oil and gas industry for a more efficient separation of crude oil and water.

Moreover, the use as a plastic and thermoplastic or elastomer additive for hydrophilization and improved wettability of thermoplastic or elastomeric surfaces, as described further below, is possible, as well as as a wetting agent for foam stabilization in liquid all-purpose cleaners, water-containing soaps or liquid dishwashing preparations, if the HLB value is greater than 8.

Furthermore, the hydrophilically modified polysiloxanes can be used as anti-blocking additives, as lubricants or lubricant additive, as softeners for cotton or paper tissues, as softeners or in softener compositions for self-emulsifying, alkylene oxide-free or shear stable emulsifiers in compositions for textile treatment.

Use as a defoaming agent such as, for example, in diesel fuel, adjuvant for the application of plant protection agents, is less preferred for this group of the siloxanes.

Compared with pure polydimethylsiloxanes, these more hydrophilic compounds have an improved solubility in polar solvents, such as alcohols, other oxygen-containing, sulfur-containing and nitrogen-containing hydrocarbons.

In a further preferred embodiment of the invention, this relates to the use of the hydrophilically/lipophilically modified polysiloxane compounds according to the invention for the production of viscosity regulators, anti-static agents, mixture components for silicone rubbers that can be cross-linked peroxidically or by hydrosilylation (platinum catalysis) to form elastomers, and there lead to the modification of surface properties, for the modification of the diffusion of gases, liquids, etc, or modify the swelling behavior of the silicone elastomers, e.g. with respect to water.

In particular, use as an additive for the hydrophilization of surfaces of polydimethylsiloxane elastomers in general or as a viscosity regulator (e.g. a thickening agent) in non-cross-linked silicic acid-containing silicone rubbers is preferred. Here, silicone rubbers means, in particular, low-viscosity casting or sealing compounds known as room temperature vulcanizing (RTV) single-component or dual-component rubbers. For these RTV-1C or 2C-rubbers, setting a high or low yield limit, depending on the application, is desired. The polysiloxanes according to the invention are used in amounts of 0.5 to 55% by wt. in relation to the silicone rubbers in the preparation of the rubber mixture or on the surface of the respective elastomers.

A preferred use is in dental impression compounds whose surface is set to be hydrophilic.

In this case, hydrophilic surfaces means that the hydrophilically organo-modified polydimethylsiloxanes according to the invention in the pure form have a contact angle with respect to water of considerably less than 90°, preferably less than 75°, measured, as specified below, in accordance with the dynamic method of determination. The statically determined contact angle is less than 50°. In contrast, a dynamic contact angle in excess of 120° is measured in polydimethylsiloxanes that have not been hydrophilically modified.

They can also be applied onto the surfaces as lubricants by immersion, pouring or spreading and removed in part by rubbing or rinsing after use or assembly as intended.

Another preferred application of the hydroxyl group-containing siloxanes is the use in siloxane foams foamed with hydrogen, particularly if the compounds according to the invention additionally contain alkenyl groups, such as vinyl groups. In these mixtures, the compounds according to the invention, together with the SiH cross-linkers in the presence of hydrosilylation catalysts, on the one hand generate hydrogen for cell formation during the cross-linking reaction, and on the other hand participate in the network foiination of the elastomer matrix. As a result, cross-linked hydrophilic polyorganosiloxane foams are obtained. For example, they are preferably used where siloxane foams are intended for skin contact, such as decubitus pads, wound dressings or wound plasters, optionally with anti-microbial active substances, etc.

In a further preferred embodiment of the invention, this relates to the use of the hydrophilically/lipophilically functionalized polysiloxane compounds according to the invention for the production of modification agents for thermoplastic materials, such as polyolefins, polyamides, polyurethanes, poly(meth)acrylates, polycarbonates. This includes the use as or the production of low-temperature impact-resistance modifiers.

For this purpose, the polyorganosiloxane compounds according to the invention themselves can be directly used as modifiers or provided beforehand in a suitable form by coating, mixing, compounding or masterbatching.

Another use of the copolymers according to the invention are coatings, such as anti-fouling, anti-stick coatings, tissue-compatible coatings, flame-retardant coatings and materials.

Other uses include ‘anti-fogging’ coatings or precursors for their preparation for non-fogging headlight lenses (inside), non-fogging panes for residential buildings, for vehicles or medical instruments, as well as additives for cleaning agents, detergents or care products, as an additive for body care products, as a demolding agent, as a biocompatible material in medical applications such as contact lenses, as a coating material for wood, paper, cardboard, natural or synthetic fibers and pulps, textile fibers or textile fabrics, as a coating material for natural fabrics such as leathers and furs. In this case, the hydroxyl-modified polyorganosiloxanes according to the invention can replace customary hydroxyl group-containing or other siloxanes with organo-functional groups in compositions in methods for leather manufacture or processing, resupplying with fat (fat-liquoring, retanning).

These uses include the production of softeners for textile fibers for the treatment of textile fibers prior to, during and after washing, of agents for modifying natural and synthetic fibers, such as hair, cotton fibers and synthetic fibers, such as polyester fibers and polyamide fibers, as well as union fabrics, of textile finishing agents, as well as of detergent-containing formulations, such as laundry detergents and cleaning products.

The preferred amounts in this case are 0.1 to 5% by wt. 0.3 to 3% by wt., based on the fiber mass.

In these preferred applications of the polyorganosiloxanes according to the invention, the hydrophilically modified polyorganosiloxanes with predominantly hydrophilic properties are used as an additive for the purpose of hydrophilization, improved wettability and anti-static finishing of thermoplastic and elastomeric surfaces. The preferred amounts in this case are 0.2 to 15% by wt. 0.5 to 10% by wt., based on the thermoplastic or elastomer composition.

Since a recognizable tendency to form micelles is observed in the hydrophilically modified polyorganosiloxanes according to the invention, they constitute a suitable basis for the coating of active substances, particularly in an aggregated form, and permit influencing the rheological properties particularly of cosmetic cremes.

In the case of the embodiment in which the polyorganosiloxanes modified according to the invention are set to be less hydrophilic, they can in principle replace customary W/O emulsifiers in known standard recipes for cosmetic preparations.

Thus, the hydrophilically/lipophilically modified polyorganosiloxanes can serve as cosmetics, body care products, paint additives, auxiliary substances in detergents, de-foaming formulations and in textile processing.

An exemplary use of the compound according to the invention as a W/O emulsifier is illustrated in the following general composition.

| | | |
|---|---|---|
| 0.1-20% | by wt. | W/O polyorganosiloxane according to the invention |
| 10-60% | by wt. | oil phase |
| 0-10% | by wt. | additives |
| 20-89.9% | by wt. | water phase |

A typical exemplary composition of a W/O creme according to the invention, which is not supposed to limit the scope of the invention, comprises the following components.

| | |
|---|---|
| 0.2-10% by wt. | polysiloxane compound according to the invention |
| 0-5% by wt. | co-emulsifier |
| 5-55% by wt. | oil or a combination of oils |
| 0-10% by wt. | stabilizers |
| 0-10% by wt. | viscosity and consistency regulators |
| 0-20% by wt. | active substances for the treatment of skin |
| 0-10% by wt. | further fillers |
| 0-10% by wt. | adjuvant |

topped up to 100% by wt. with water.

Analytical Characterizations:

Gel Permeation Chromatography (GPC)

The GPC measurements in chloroform took place in an apparatus consisting of a Waters 717 Plus autosampler, a TSP P 100 pump and a set of three PSS SDV columns (104/500/50 Å). Signal determination took place using a Wyatt Optilab DSP RI detector.

For the measurements in DMF, to which 1 g/l lithium bromide had been added, an Agilent 1100 Series with Poly-HEMA column, RI and UV (254nm) detector was used as a measuring instrument. The measurements were performed at 35° C. and a flow rate of 1.0 ml/min. Calibration took place with linear polystyrene standards by the Polymer Standards Service. Signal determination was carried out using a Wyatt Optilab DSP RI detector.

NMR Spectroscopy

Nuclear magnetic resonance spectra were recorded at room temperature with the following devices:
¹H spectra: Bruker AC 300 for 300 MHz
²⁹Si spectra: Bruker AMX 400 for 79.49 MHz

The chemical shifts are given in ppm and relate to the proton signal of the deuterated solvent.

Contact Angle Measurement

The measurements of the contact angles with respect to water were performed on a Dataphysics Contact Angle System OCA 20 and were evaluated using the SCA 20 software. The indicated contact angles are in each case average values from 5 measurements of a dynamic determination in accordance with Halliwell, C. M.; Cass, A. E. G.; Analytical Chemistry 2001, 73, 2476-83.

In the case of a measurement of the contact angle a with water, the following generally applies for the surface properties of a material:

α<90°: hydrophilic surface

α≈90°: hydrophobic surface

α>90°: superhydrophobic surface

### EXAMPLES

The 1,2-O-isopropylidene-3-allyloxy-1,2-propanediol (“solketal”) used for the following hydrosilylations in the Examples 1-4

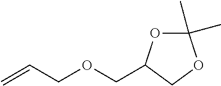

was previously produced by means of a Williamson synthesis from allyl bromide and the ketal of the glycerin in accordance with the following scheme

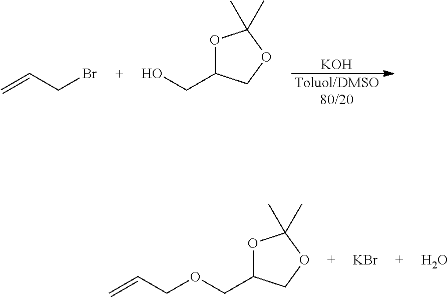

Synthesis of 1,2-O-isopropylidene-3-allyloxy-1,2-propanediol (II)

In a 1 l round flask, 28 g (0.5 mol) finely mortar-ground potassium hydroxide was added, while stirring, to a solution of 28.8 (0.2 mol) solketal in 400 ml of a 20:80 mixture of DMSO:toluene, and dissolved. 20.8 ml (0.24 mol) allyl bromide was added to the solution and the resulting mixture was stirred for 12 h at 25° C. room temperature. For processing, the mixture was filtered and washed to neutralization with saturated ammonium chloride solution. The aqueous phase was subsequently extracted with about 100 ml toluene three more times. The toluene phases were united, dried with sodium sulfate, and the solvent was evaporated in a rotavap. 29.26 g (85% of theory) of the product (II) were obtained.

### Example 1

### Parent Material

1a)

Hydrosilylation of 1,2-O-isopropylidene-3-allyloxy-1,2-propanediol (II)

In a 100 ml Schlenk flask, 6.00 g of a polydimethylmethylhydrogensiloxane with the molecular formula MD₁₂₆D^{H}₁₁M was dissolved together with 2.00 g 1,2-O-isopropylidene-3-allyloxy-1,2-propanediol (II) in 30 ml dioxane and the solution was heated to 70° C. with stirring. The air was removed from the flask by letting argon flow in, and 30 μl of a solution of a platinum catalyst (1,3-divinyl-1,3-tetramethyldisiloxane Pt complex 2% Pt. ('Karstedt catalyst')) was added in the argon counterflow. After the addition of the catalyst, the flask was sealed with a septum, which was then penetrated by a cannula attached to a balloon filled with argon. After about 12 hours of stirring, the mixture was allowed to cool down and the solvent was evaporated in the rotavap. For further purification, the reaction product was stirred for 12 h at 70° C. at 1 mbar. 6.63 g (90% of theory) of a product with structural units of the formula (III) were obtained, i.e. the units with the index f and g can be present with random distribution.

¹H-NMR (300 MHz, CDCl₃) d [ppm]=−0.06-0.15 (s, Si—CH₃), 0.42-0.55 (br, Si—CH₂), 1.36 (s, R₂C(CH₃)₂), 1.42 (s, R₂C(CH₃)2), 1.55-1.67 (br, Si—CH₂—CH₂), 3.37-3.45 (br, CH₂—CH₂—O), 3.48-3.56 (m, RO—CH₂—CHR—OR), 3.70-3.77 (m, O—CH₂—CHOR—CH₂—OR), 4.02-4.10 (m, O—CH₂—CHOR—CH₂OR), 4.22-4.30 (m, R₂CH—OR)

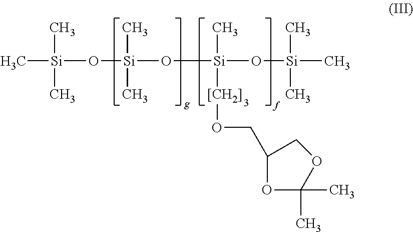

1b) 2nd Stage:

Removal of the Protective Group of the Polyorganosiloxanes Grafted with 1,2-O-isopropylidene-3-allyloxy-1,2-propanediol

To remove the protective groups, 6.60 g of the polymer of Example 1a was stirred with 1 g of an acid ion-exchange resin Dowex 50 at 25° C. for 60 minutes in 40 ml of a 1:1 mixture of methanol and pentane. The ion exchanger was then removed from the mixture by filtration, the phases were separated and the pentane phase was extracted by shaking with methanol two more times. The methanolic phase was finally freed from the solvent for 12 h at 1 mbar. 6.15 g (97% of theory) of a product with structural units of the general molecular formula (IV) was obtained. The molecular weight had increased to the value indicated in Tab. 1.

¹H-NMR (300 MHz, DMSO-d6) d [ppm]=−0.29-0.18 (s, Si—CH₃), 0.34-0.53 (br, Si—CH2), 1.39-1.57 (br, Si—CH2-CH2), 3.11-3.44 (br, CH2OR, CH2OH), 3.48-3.59 (br, CHOH), 4.25-4.55 (br, R—OH).

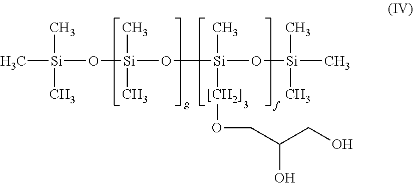

Alternatively, compounds of the formula IV according to the invention can also be prepared by reacting hydrogenpolysiloxanes with allyl alcohol or protected allyl alcohol and subsequently reacting the obtained hydroxypropylpolysiloxane compounds with glycidol, in accordance with the reaction path described in claim 1.

### Example 2

### Parent Material

2a)

Hydrosilylation of 1,2-O-isopropylidene-3-allyloxy-1,2-propanediol

In a 100 ml Schlenk flask, 6.00 g of a polydimethylmethylhydrogensiloxane with the molecular formula MD₃₉D^{H}₁₆M was dissolved together with 6.10 g 1,2-O-isopropylidene-3-allyloxy-1,2-propanediol in 30 ml dioxane and the solution was heated to 70° C. with stirring. The air was removed from the flask by letting argon flow in, and 30 μl of a solution of a platinum catalyst (1,3-divinyl-1,3-tetramethyldisiloxane Pt complex 2% Pt. (‘Karstedt catalyst’)) was added in the argon counterflow. After the addition of the catalyst, the flask was sealed with a septum. After about 12 hours of stirring, the mixture was allowed to cool down and the solvent was evaporated in the rotavap.

For further purification, the reaction product was stirred for 12 h at 70° C. at 1 mbar. 9.32 g (92% of theory) of a product with structural units of the general molecular formula (III) was obtained.

¹H-NMR confirms an OH content of approx. 2 mmol/g and 10 mol. % modified siloxy units.

2b

Removal of the Protective Group of the Polyorganosiloxanes Grafted with 1,2-O-isopropylidene-3-allyloxy-1,2-propanediol

As in Example 1b, 9.30 g of the polymer 2a) was stirred for this purpose with 1 g acid ion-exchange resin Dowex 50 at room temperature for 60 minutes in 40 ml of a 1:1 mixture of methanol and pentane. 8.41 g (95% of theory) of a product with structural units of the general molecular formula (IV) was obtained. The molecular weight had increased to the value indicated in Tab. 1.

¹H-NMR confirms an OH content of approx. 5.2 mmol/g and 27.8 mol. % modified siloxy units.

### Example 3

### Parent Material

3a

Hydrosilylation of 1,2-O-isopropylidene-3-allyloxy-1,2-propanediol

Example 1 was repeated by using in this case, instead of the polydimethylmethylhydrogensiloxane mentioned there, 6.00 g of a polydimethylmethylhydrogensiloxane with the molecular formula MD₁D^{H}_{9.5}M together with 16.40 g 1,2-O-isopropylidene-3-allyloxy-1,2-propanediol dissolved in 30 ml dioxane. 14.91 g (88% of theory) of a product with structural units of the general molecular formula (III) was obtained.

3b

Removal of the Protective Group of the Polyorganosiloxanes Grafted with 1,2-O-isopropylidene-3-allyloxy-1,2-propanediol

The protective groups were removed with 14.90 g polymer from the Example 3a, as in 1b or 2b.

12.04 g (95% of theory) of a product with structural units of the general molecular formula (IV) was obtained. The molecular weight had increased to the value indicated in Tab. 1.

¹H-NMR confirms an OH content of approx. 8 mmol/g and 66.7 mol. % modified siloxy units.

### Example 4

### Parent Material

In accordance with the instruction from Example 1, a polymethylhydrogensiloxane having the molecular formula MD^{H}₂₆M was also made to react with 1,2-O-isopropylidene-3-allyloxy-1,2-propanediol and the protective group was removed.

¹H-NMR confirms an OH content of approx. 9.5 mmol/g and 93 mol. % modified siloxy units.

### Example 5

5a) Hydrosilylation of Allylamine (Parent Material)

In a 100 ml Schlenk flask, 6 g of a polydimethyl-co-methylhydrogensiloxane with the molecular formula MD₃₉D^{H}₁₆M was dissolved together with 2.10 g allylamine in 30 ml dioxane and the solution was heated to 50° C. with stirring. The air was removed from the flask by letting argon flow in, and 30 μl of a solution of a platinum catalyst (1,3-divinyl-1,3-tetramethyldisiloxane Pt complex 2% Pt. (‘Karstedt catalyst’)) was added in the argon counterflow. After the addition of the catalyst, the flask was sealed with a septum. After about 12 hours of stirring, the mixture was allowed to cool down and the solvent was evaporated in the rotavap.

For further purification and removal of solvents and glycidol, the reaction product was stirred for 12 h at 70° C. at 1 mbar. 6.33 g (86% of theory) of a product with structural units of the general molecular formula (V) was obtained, in addition to small proportions of isomeric forms, i.e. addition of allylamine in the 2-position.

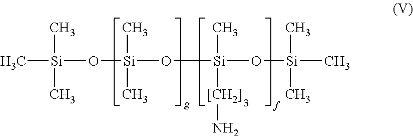

5b) (Product According to the Invention)

Grafting of Aminoalkyl-Functionalized Polydimethylsiloxanes with Glycidol and Further Oligomerization

A 100 ml round flask was filled with 1.00 g of the amino-functionalized polydimethylsiloxane and put under an argon atmosphere. The polymer from Example 5a was dissolved by adding 30 ml dry THF, and 3.62 g glycidol was added to the resulting solution under vigorous stirring. The resulting mixture was stirred for 12 h at 25° C. room temperature. For processing, the solvent was evaporated in the rotavap, and then the non-reacted glycidol by stirring at 80° C. and 1 mbar.

3.25 g (89% of theory) of a product with structural units of the schematic molecular formula (VI) was obtained. The molecular weight had increased to the value indicated in Tab. 1. The molecular weight increase corresponds to about 11 oligomerized gylcidol units on average on each nitrogen. ¹H-NMR confirms an OH content of approx. 11.6 mmol/g and 28.1 mol. % modified siloxy units.

¹H-NMR (300 MHz, DMSO-d6) d [ppm] 3.19-3.79 (br, CH2-OR, CH2-OH, CH—OR, CH—OH), 4.47-4.88 (br, R—OH)

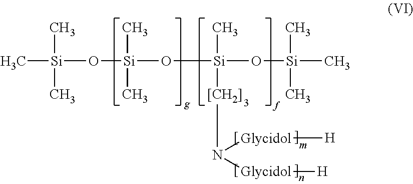

to be understood schematically. The exact structure of the glycidol addition products cannot be determined exactly by means of the spectroscopic data. Moreover, mixtures of glycidol addition products may be present. What can be determined exactly is the increase of mass due to glycidol addition by means of molecular weight determination of the end product.

Example 6

6a) Hydrosilylation of Allylamine

Hydrosilylation took place as in Example 5a) but with 6 g of a polydimethylmethylhydrogensiloxane having the molecular formula MD₁D^{H}_{9.5}Mn, which was dissolved in 30 ml dioxane together with 5.40 g allylamine.

7.89 g (82% of theory) of a product with structural units of the general molecular formula (V) was obtained.

6b)

Grafting of Aminoalkyl-Functionalized Polydimethylsiloxanes with Glycidol and Further Oligomerization

A 100 ml round flask was filled with 1.00 g of the amino-functionalized polysiloxane 6a) and put under an argon atmosphere. The polymer was dissolved by adding 30 ml dry THF, and 7.33 g glycidol was added to the resulting solution under vigorous stirring.

The resulting mixture was stirred overnight at room temperature.

For processing, the solvent was evaporated in the rotavap, and then the non-reacted glycidol was removed by stirring at 80° C. under high vacuum.

5.61 g (88% of theory) product of the schematic formula (VI) was obtained.

The molecular weight increase corresponds to about 11 oligomerized gylcidol units on average on each nitrogen. ¹H-NMR confirms an OH content of approx. 13.4 mmol/g and 76 mol. % modified siloxy units.

### Example 7

Moreover, the following dimethylhydrogensiloxy-terminated polydimethylsiloxanes a) of the formula M^{H}D₈M^{H} were hydrosilylated with allylamine and then b) reacted with glycidol.

The molecular weight increase corresponds to about 11 oligomerized gylcidol units on average on each nitrogen. ¹H-NMR confirms an OH content of approx. 10.7 mmol/g and 20 mol. % modified siloxy units. A product with the general formula (VII) is obtained.

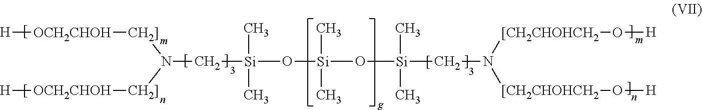

Indices m+n=11

### Example 8

In analogy to Example 7, a polyorganosiloxane according to the invention consisting of M^{H}D₂₇₀M^{H} is prepared with allylamine and subsequent reaction with glycidol.

The molecular weight increase corresponds to about 11 oligomerized gylcidol units on average on each nitrogen. ¹H-NMR confirms an OH content of approx. 1.3 mmol/g and 0.7 mol. % modified siloxy units. A product with the general formula (VII) with g=270 is obtained.

Solubility tests in various solvents were carried out with the glycidol-modified polyorganosiloxanes according to the invention.

Whereas the modified polyorganosiloxane from Example 8, due to its comparatively long PDMS chain, still dissolves well in non-polar organic solvents such as pentane to chloroform, i.e. dc (dielectric constant) from 1.8 to 4.8, but not or less well in polar solvents with a dc of 18.6 to 80.4, the reverse behavior is observed in the compounds from the Examples 5 to 7. These compounds are soluble substantially only in methanol and water (soluble in this case means 10 g modified polyorganosiloxanes per 100 ml solvent at 25° C.). This proves that the compounds according to the invention can be varied within broad limits with regard to their hydrophilic properties.

Table 1 summarizes the preparation examples.

TABLE 1
Examples 1 to 8:

| | | | | Mn | | |
|---|---|---|---|---|---|---|
| | Parent SiH | Mn Parent SiH | | End Product | % by wt. | mmol |
| Example | Siloxane | Siloxane [g/mol] | Side Chain | [/g/mol] | Side Chain | OH/g |
| 1* | MD₁₂₆D^{H}₁₁M | 10000 | 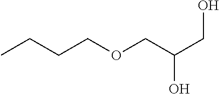 | 11,500 | 13 | 2.0 |
| 2* | MD₃₉D^{H}₁₆M | 4000 | 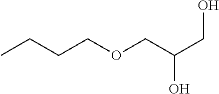 | 6,100 | 35 | 5.2 |
| 3* | MD₁D^{H}_{9.5}M | 850 | 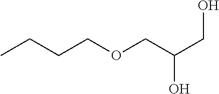 | 1,900 | 57 | 8.3 |
| 4* | MD^{H}₂₆M | 1700 | 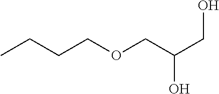 | 4,600 | 67 | 9.5 |
| 5 | MD₃₉D^{H}₁₆M | 4000 | 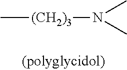 | 16,800 | 78 | 11.6 |
| 6 | MD₁D^{H}_{9.5}Mn | 900 | 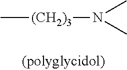 | 7,200 | 90 | 13.4 |
| 7 | M^{H}D₈M^{H} | 850 | 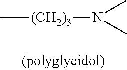 | 2615 | 72 | 10.7 |
| 8 | M^{H}D₂₇₀M^{H} | 20114 | 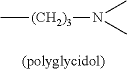 | 22000 | 9 | 1.3 |

*Parent Material

1-15. (canceled)

16. Polyorganosiloxane compounds, obtained by the reaction of polyorganosiloxane compounds of the formula (I):
[MₐD_{b}T_{c}Q_{d}]ₑ (I)
wherein
M=R₃SiO_{1/2},
D=R₂ SiO_{2/2},
T=RSiO_{3/2},
Q=SiO_{4/2},
with
a=1-10
b=0-1000
c=0-1
d=0-1
e=1-10
wherein
R=is an organic group,
provided that R comprises at least one group R¹,
wherein R¹ is a monovalent, straight-chained, cyclic or branched, saturated or unsaturated C₂ to C₂₀ hydrocarbon residue, which can contain one or more groups selected from —O— and 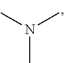
and which comprises at least one group selected from —OH, —SH, —NH— and —NH₂,
with a glycidol compound of the formula (II), 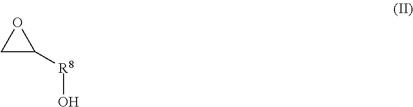
wherein R⁸ is selected from divalent C₁ to C₈ hydrocarbon residues, such as, in particular, methylene (—CH₂—),
provided that the obtained polyorganosiloxane compounds comprise at least one residue R¹ which comprises polyglycidol residues of the formula
-(glycidol)ₓ
wherein x>1, wherein the polyglycidol residue is formed by ring-opening polymerization of the epoxy groups of the gycidol molecules of the formula (II).

17. The polyorganosiloxane compounds according to claim 16, wherein the compounds of the formula (I) comprise siloxy units selected from the following formulae: 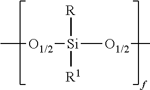
wherein
R, if several of the aforementioned siloxy units are present, can be the same or different and is selected from C₁ to C₂₂ alkyl, which can optionally be substituted by one or more fluorine atoms,
C₂ to C₂₂ alkenyl, and C₆-C₁₀ aryl,
R¹ is defined as above, and
f is 0-600, 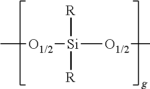
wherein
R can be the same or different in a single siloxy unit or, if several siloxy units are present, can be the same or different in different ones of the siloxy units and is selected from C₁ to C₂₂ alkyl, which can optionally be substituted by one or more fluorine atoms, C₂ to C₂₂ alkenyl, and C₆-C₁₀ aryl, and
g is from 0-700, 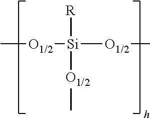
wherein
R, if several of the aforementioned siloxy units are present, can be the same or different and is selected from C₁ to C₂₂ alkyl, which can optionally be substituted by one or more fluorine atoms, C₂ to C₂₂ alkenyl, and C₆-C₁₀ aryl, and
h is from 0-10, 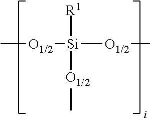
wherein R¹, is defined as above, and
i is from 0-10, 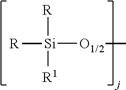
wherein
R, if several of the aforementioned siloxy units are present, can be the same or different and is selected from C₁ to C₂₂ alkyl, which can optionally be substituted by one or more fluorine atoms, C₂ to C₂₂ alkenyl, and C₆-C₁₀ aryl,
R¹ is defined as above, and
j=0-30, 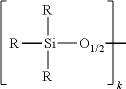
wherein
R, if several of the aforementioned siloxy units are present, can be the same or different and is selected from C₁ to C₂₂ alkyl, which can optionally be substituted by one or more fluorine atoms, C₂ to C₂₂ alkenyl, and C₆-C₁₀ aryl, and
k is from 0-30, 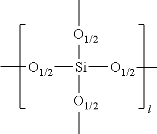
wherein 1=0-10,
f+g+h+i+j+k+l=12 to 1000.

18. The polyorganosiloxane compounds according to claim 16, wherein the compounds of the formula (I) comprise two or more residues R¹.

19. The polyorganosiloxane compounds according to claim 16, wherein, in the compounds of the formula (I), at least one of the following provisos is satisfied:
(a) R is selected from: C₁ to C₁₀ alkyl, which can optionally be substituted with 1 to 13 fluorine atoms, C₂ to C₈ alkenyl and phenyl,
(b) R¹ is selected from: monovalent, straight-chained, cyclic or branched, saturated or unsaturated C₁ to C₁₀ hydrocarbon residues, which may contain one or more groups selected from —O— and 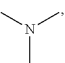
and which comprise at least one group selected from —OH, —NH— and —NH₂,
(c) f=1 to 200,
(d) g=10 to 700,
(e) h=0 to 5,
(f) i=0 to 5,
(g) 1=0 to 5, and
(h) f+g+h+i+j+k+l=10 to 500.

20. The polyorganosiloxane compounds according to claim 16, wherein, in the compounds of the formula (I), one or more of the following features are satisfied:
(a) R is selected from: C₁ to C₆ alkyl, which can optionally be substituted with 1 to 13 fluorine atoms, vinyl and phenyl, and
(b) R¹ is selected from: monovalent, straight-chained, cyclic or branched, saturated or unsaturated C₂ to C₁₀ hydrocarbon residues, which may contain one or more groups selected from —O— and 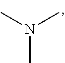
and which comprise at least one group —NH₂.

21. The polyorganosiloxane compounds according to claim 16, wherein the polyglycidol residues have the formula
-(glycidol)ₓ
which arise from the ring-opening polymerization or oligomerization of glycidol compounds of the formula (II), 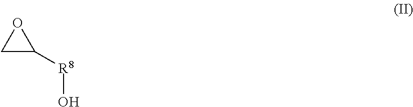
wherein R⁸ is selected from divalent C₁ to C₈ hydrocarbon residues and
wherein x is from 2 to 20.

22. The polyorganosiloxane compounds according to claim 16, wherein R¹ is selected from the residues of the formula:
—R³—Y,
wherein
R³ is selected from divalent, straight-chained, branched or cyclic alkyl residues with up to 20 carbon atoms, which may optionally comprise one or more ether groups —O— and which may optionally be substituted with one or more hydoxyl groups, and wherein Y is at least one group selected from —OH, —SH, —NH₂ or —NHR⁴, wherein R⁴ is selected from straight-chained, branched or cyclic alkyl residues with up to 10 carbon atoms.

23. The polyorganosiloxane compounds according to claim 22, wherein R¹ is selected from residues of the formula:
—(CH₂)₃—O—X—Y,
wherein X is selected from the group consisting of: 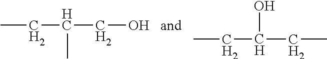
and Y is defined as above,
—(CH₂)ₙY
wherein n is 1 to 8 and Y is as defined above, and
—R³—Y,
wherein R³ is an alkyl group with 8 to 20 carbon atoms, which comprises a cycloalkyl group, and Y is as defined above.

24. The polyorganosiloxane compounds according to claim 16, wherein the compounds of the formula (I), in relation to the total amount of the siloxy units, comprise at least 25 mol-% siloxy units, which comprise residues R¹.

25. The polyorganosiloxane compounds according to claim 16, wherein the molar ratio of the residues R¹ to the glycidol units in the obtained polyorganosiloxane compounds is at least 1:5.

26. The polyorganosiloxane compounds according to claim 16, which comprise at least 8 mmol hydroxyl groups per gram of the polysiloxane compound.

27. The polyorganosiloxane compounds according to claim 16, having the formula, 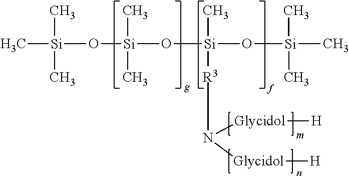
or the formula, 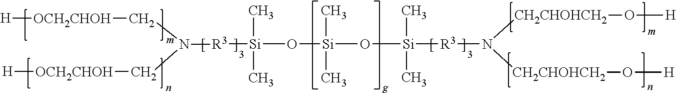
wherein
f=1 to 200,
g=10 to 700,
R³ is selected from monovalent, straight-chained, branched or cyclic alkyl residues with up to 20 carbon atoms, which may optionally comprise one or more ether groups —O— and which may optionally be substituted with one or more hydoxyl groups, and wherein Y is at least one group selected from —OH, —SH, —NH₂ or —NHR⁴, wherein R⁴ is selected from straight-chained, branched or cyclic alkyl residues with up to 10 carbon atoms,
m=0 to 20,
n=0 to 20, and
at least one of m and n is greater or equal to 2, and
glycidol means a glycidol unit arising from the epoxide ring-opening reaction of glycidol compounds of the formula (II): 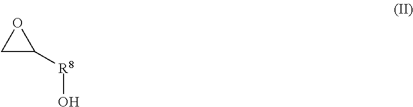
wherein R⁸ is selected from divalent C₁ to C₈ hydrocarbon residues.

28. A method for the preparation of the polyorganosiloxane compounds according to claim 16, comprising reacting compounds of the formula (I) with glycidol compounds of the formula (II) 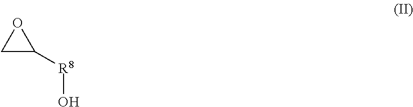
wherein R⁸ is selected from divalent C₁ to C₈ hydrocarbon residues.

29. A method for the preparation of the polyorganosiloxane compounds according to claim 16, comprising reacting compounds of the formula (I) with more than 1 mol glycidol compounds of the formula (II) per residue R¹.

30. A use of the polyorganosiloxane compounds obtained in accordance to claim 1 as
emulsifier,
defoaming agent,
coagulant for rubber latexes,
phase separating agent in crude oil extraction,
hydrophilization additive,
wetting agent and adjuvant in plant protection emulsions,
anti-static agent,
anti-fogging coating,
hydrogen-forming additive in Si—H group-containing compositions,
fiber treatment agent,
foam stabilizer, in particular for rigid and flexible polyurethane foams, or
cross-linking component in the production of elastomers or elastomeric foams.

31. The polyorganosiloxane compounds according to claim 19, wherein,
f=1 to 100,
g=10 to 200,
h=i=l=0, and
f+g+h+i+j+k+l=10 to 200.

32. The polyorganosiloxane compounds according to claim 16, wherein,
f=1 to 50,
g=10 to 150,
h=i=l=0, and
f+g+h+i+j+k+l=10 to 150.

33. The polyorganosiloxane compounds according to claim 16, wherein the polyglycidol residues have the formula
(glycidol)ₓ
which arise from the ring-opening polymerization or oligomerization of glycidol compounds of the formula
(II), and wherein x is from 4 to 18.

34. The polyorganosiloxane compounds according to claim 16, having the formula 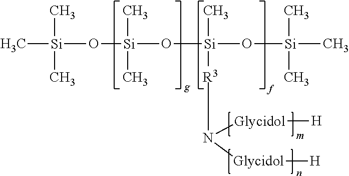
or the formula 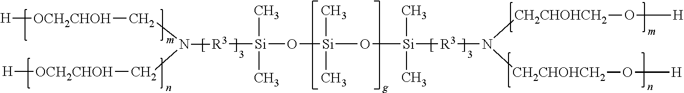
wherein
f=1 to 100,
g=10 to 200,
R³ is selected from monovalent, straight-chained, branched or cyclic alkyl residues with up to 20 carbon atoms, which may optionally comprise one or more ether groups —O— and which may optionally be substituted with one or more hydoxyl groups, and wherein Y is at least one group selected from —OH, —SH, —NH₂ or —NHR⁴, wherein R⁴ is selected from straight-chained, branched or cyclic alkyl residues with up to 10 carbon atoms,
m=0 to 20,
n=0 to 20, and
at least one of m and n is greater than or equal to 2, and
glycidol means a glycidol unit arising from the epoxide ring-opening reaction of glycidol compounds of the formula (II).

35. The polyorganosiloxane compounds according to claim 16, having the formula 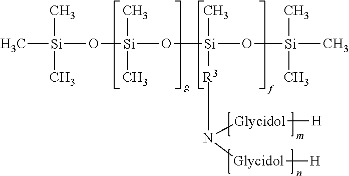
or the formula 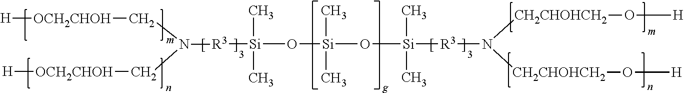
wherein
f=1 to 50,
g=10 to 150,
R³ is selected from monovalent, straight-chained, branched or cyclic alkyl residues with up to 20 carbon atoms, which may optionally comprise one or more ether groups —O— and which may optionally be substituted with one or more hydoxyl groups, and wherein Y is at least one group selected from —OH, —SH, —NH₂ or —NHR⁴, wherein R⁴ is selected from straight-chained, branched or cyclic alkyl residues with up to 10 carbon atoms
m=0 to 20,
n=0 to 20, and
at least one of m and n is greater than or equal to 2, and
glycidol means a glycidol unit arising from the epoxide ring-opening reaction of glycidol compounds of the formula (II).
